(19) United States
(12) Patent Application Publication
(10) Pub. No.: US 2025/0119298 A1
(43) Pub. Date: Apr. 10, 2025

(54) SYSTEM AND METHOD FOR QUANTUM SAFE TRUST IDENTITY AND AUTHENTICATION

(71) Applicant: FORTYTWO42 LABS LLP, Pune (IN)

(72) Inventors: Sanjay Deshpande, Pune (IN); Sayani Lahiri, Pune (IN); Debrup Chatterjee, Pune (IN); Mohit Badhe, Pune (IN)

(73) Assignee: FORTYTWO42 LABS LLP, Pune (IN)

(21) Appl. No.: 18/904,396

(22) Filed: Oct. 2, 2024

(30) Foreign Application Priority Data
Oct. 4, 2023 (IN) 202321066705

(51) Int. Cl. H04L 9/32; H04L 9/08; H04L 9/30

(52) U.S. Cl. CPC H04L 9/3247; H04L 9/085; H04L 9/0891; H04L 9/3073

(57) ABSTRACT

A quantum safe method provides for creation and verification of a digital signature. The method includes steps of: encrypting, a plurality of shares associated with a User A, by using an encryption scheme to obtain encrypted plurality of shares; passing, the plurality of encrypted shares associated with the User A, to the platform; re-encrypting, the plurality of the shares to obtain the encrypted plurality of shares by the platform; decrypting, the plurality of shares shared by the User B; receiving, the plurality of shares associated with the User B from the User B by the User A; sharing, by the platform, half of the plurality of shares encrypted for the User A, with the User A and the other half of the plurality of shares encrypted for the User B, with User B; independently combining, by the User A, the plurality of shares associated with the User A with the plurality of shares associated with the User B, received from the User B; independently combining, by the User B, the plurality of shares associated with the User B with the plurality of shares associated with the User A, received from the User A; re-creating, the same secret key which is the “collective identity” for the User A and the User B in context; and creating, the collective ID between the User A and the User B to enable establishing secure communication between the user A, the User B, and the platform.

### TECHNICAL FIELD

The present disclosure relates to post-quantum cryptography (PQC), particularly it specifies a cryptographic process for generating digital signature which is quantum safe.

### BACKGROUND

Quantum computing is a type of computing that uses quantum mechanics, a branch of physics, to store and process information. Unlike classical computers that use bits to represent information as either 0 or 1, quantum computers use quantum bits or qubits, which can represent a 0, 1, or both simultaneously, allowing for much faster processing. This makes quantum computers particularly useful for solving certain problems that classical computers struggle with, such as encryption, optimization, and simulation.

Quantum computing is widely said to be the future of computing as we know it-one that could allow human kind to perform extremely complex computations very fast that are simply impossible using today's computing technologies. The existing systems are based on the assumption that factoring large integers is computationally intractable. However, there exist algorithms which show that factoring large integers is efficient on an ideal quantum computer. Existing technologies rely heavily on cryptographic techniques like digital signatures for digital security. Hence, quantum attacks could break these cryptographic algorithms and consequently the integrity and reliability of technologies will be compromised.

For 20 years scientists and engineers have been saying that “someday” they'll build a full-fledged quantum computer able to perform useful calculations that would overwhelm any conventional supercomputer.

Currently there are various organizations in race to develop the first fully functional quantum computer. IBM is one of the leading organizations currently developing the quantum computers. IBM made its aspirations more concrete by publicly announcing a “road map” for the development of its quantum computers, including the ambitious goal of building one containing 1000 qubits by 2023. IBM's current largest quantum computer, Osprey, revealed this month, contains 433 qubits. Right now, Google's Sycamore computer has about 53 working qubits.

A Canadian company called DWAVE has a quantum computer with 512 qubits, but it has very high error rates on its qubits and is based on another principle called quantum annealing. To run Shor's on 2048-bit RSA would require at least 10,000 qubits. It will probably be a while before such a machine can be built.

An alternative cryptographic technology that do not rely on computational complexity is a need of the hour to prevent quantum attacks. The proposed invention presents a cryptographical method which is based on information security, hence making it quantum safe.

### SUMMARY

The present invention provides a system for creation and verification of digital signature which is quantum safe. The invention comprises of four steps:
a. QUANTUM SAFE I-AM® CI2
b. Encryption scheme
c. QUANTUM SAFE I-AM® CI2—Digital Signature

The proposed method is based on the classical cryptographic method of Shamir's secret sharing which is used to share a secret amongst n users so that at least k users need to come together to recreate the secret. This method is based on information-security which means that the security of the method does not rely on complicated calculation but on the availability of information.

The encryption scheme derived in the proposed method is also based on a multi-key variant of homomorphic encryption (MKHE) using the BFV scheme. This method depends on the cryptographic hardness of ring-learning with errors (R-LWE).

The proposed method has a signer-verifier setup which works using the I-AM® Crypto-ID. There are two participating users-one who signs a document and the other verifies the signature, who interact between each other through the Pi platform through a secured channel of communication that is established by a QUANTUM SAFE I-AM® CI2 key exchange protocol. The verifier uses a zero-knowledge-proof which means that, during the process, the user can verify the signer's ownership without using any of the signer's private information, hence ensuring a cryptographically secure process.

To initiate the process both Verifier and Signer run the I-AM®-CIϕ handshake with Pi-Control™ Platform and generate the secret keys K_{A} and K_{B} respectively. In the next step, Signer & Verifier run the I-AM®-CI2 Identity Based Authenticated Key Agreement Protocol in order to generate the symmetric key K_{AB}. This shared secret key is called as the collective identity.

In an implementation a quantum safe method for creation and verification of digital signature is disclosed. The method comprises encrypting 202, a plurality of shares associated with a User A 104, by using an encryption scheme to obtain encrypted plurality of shares. Passing 204, the plurality of encrypted shares associated with the User A 104, to the platform 102. Re-encrypting 206, the plurality of the shares to obtain the encrypted plurality of shares by the platform 102. The method further comprises decrypting 208, the plurality of shares shared by the User B 106. Receiving 210, the plurality of shares associated with the User B 106 from the User B 106 by the User A 104. Sharing 212, by the platform 102, half of the plurality of shares encrypted for the User A 104, with the User A 104 and the other half of the plurality of shares encrypted for the User B 106, with User B 106. Further independently combining 214, by the User A 104, the plurality of shares associated with the User A 104 with the plurality of shares associated with the User B 106, received from the User B 106. Independently combining 216, by the User B 106, the plurality of shares associated with the User B 106 with the plurality of shares associated with the User A 104, received from the User A 104. Further re-creating 218, the same secret key which is the “collective identity” for the User A 104 and the User B 106 in context. Creating 220, the collective ID between the User A and the User B to enable establishing secure communication between the user A, the User B, and the platform 102.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1, illustrates a system in accordance with an exemplary embodiment of the present disclosure.

FIG. 2, illustrates an exemplary method for exchanging keys, and distribution of keys in accordance with the present disclosure.

FIG. 3, illustrates a technical flow of key exchange between two registered users using ring-LWE based multi-key homomorphic encryption, in accordance with an exemplary embodiment of the present disclosure.

FIG. 4, illustrates a technical flow to represent a signer/verifier protocol, in accordance with an exemplary embodiment of the present disclosure.

### DETAILED DESCRIPTION OF THE INVENTION

Some embodiments of the present disclosure, illustrating all its features, will now be discussed in detail. It must also be noted that as used herein and in the appended claims, the singular forms “a”, “an” and “the” include plural references unless the context clearly dictates otherwise. Although any systems and methods similar or equivalent to those described herein can be used for creation and verification of digital signature which is quantum safe, i.e., the digital signature cannot be hacked or accessed using a quantum computing system or conventional computing system without the access rights.

Further a Pi-Control™ Platform as disclosed in the present disclosure may refer to a centralized or distributed platform that may be hosted on a server, or a remote server, or a cloud server. Further in present disclosure the Pi-Control™ Platform may be interchangeably referred as the platform.

An I-AM® Crypto-ID as disclosed in the present disclosure may refer to unique identification created, generated, and/or assigned by the platform to user or users accessing the platform. Further the I-AM® Crypto-ID may refer to K_{A} for a User A, and K_{B} for User B.

An I-AM®-CIϕ handshake as disclosed in the present disclosure may refer to a secured, and encrypted communication between the users and the platform. The secured, and the encrypted communication may be configured to transpire over known communication protocol like 802.11 (Wi-Fi), 802.15 (including Bluetooth™), 802.16 (Wi-Max), 802.22, Cellular standards such as CDMA, CDMA2000, WCDMA, 5G, Radio Frequency (e.g., RFID), Infrared, laser, Near Field Magnetics, Ethernet, Internet etc.

The present disclosure in an aspect may disclose a system and a method that is post-quantum safe as the security relies on the mathematical hardness of ring-learning with error (R-LWE) and the complexity of solving a shortest vector problem. Further the system and method may be configured to implement an information-security protocol under the R-LWE concept.

Further in another aspect the system and the method is based on the concept of multi-key homomorphic encryption which relies on arithmetic operations between ciphertexts created by multiple keys which can be decrypted by multiple users using their individual secret keys without sharing any private information apriori.

Further in another aspect, the notion of verifiability of the public information of users may be included to ensure reliability within the zero-trust environment of Pi-Control™, ie a user should be able to verify that the public information of another user he is communicating with has not been compromised by a dishonest server.

Further in another aspect the system and the method may be configured to conduct all exchange of information between the users and platform using zero-knowledge proof protocol. The zero-knowledge proof protocol may be configured to enable the users to interact with the platform without the need to share any private information.

The Zero-Knowledge Proof protocol relies on proving that something is true without revealing any other information. Zero-knowledge proof protocol comprises a prover who wants to convince a verifier that some statement is true without revealing any other information, e.g., verifier learns that the prover has more than X in his bank account but nothing else (i.e., the actual amount is not disclosed). Thus, the method as disclosed in the present aspect does not provide any private information to be stored in the platform and hence preventing any sort of data breach from the server's end.

The zero-knowledge proof protocol is associated with at least three attributes completeness, Soundness, and Zero-knowledge. The attribute completeness relates to a prover to convince a verifier. Further the attribute soundness relates to a cheater not being able to convince a verifier. The attribute Zero-knowledge further relates to interaction that reveal if a statement is true and nothing else.

In another aspect of the system and the method as disclosed a pseudorandom security is maintained since the public keys are randomly generated every time, hence they act as ephemeral keys.

Further during the creation of shared secret key between two users all information exchange happens through the secured channel created between a user and the platform hence only registered users can create a shared secret key.

The classical security describes the difficulty of breaking a cryptosystem using classical computation systems. The quantum security describes the difficulty of breaking a cryptosystem using quantum computers.

The traditional cryptographic protocols provide classical security as there are no known methods exist to break them using classical computers. But there are quantum algorithms (Shor's Algorithm) that can use Quantum Computers to break these cryptosystems.

The cryptosystems used in the embodiment provides both classical & quantum security. That means the cryptographic protocols of Pi-Control™ Platform can neither be breakable using classical system not by quantum systems.

The proposed method is based on the classical cryptographic method of Shamir's secret sharing which is used to share a secret amongst n users so that at least k users need to come together to recreate the secret. For e.g., if a key code is to be shared with 10 users, then at least 6 users need to connect to enable sharing of the key code. This method is based on information-security which means that the security of the method does not rely on complicated calculation but on the availability of information.

The ring-LWE is a family of problems given by the following parameters:
a positive integer modulus q to define the quotient ring R_{q} [symbol] R/qR= [symbol] [X]/ [symbol] X²^{^{k}}+1 [symbol]
an error distribution χ over R
   The RLWE search problem is to find a uniformly random secret sϵR_{q}, given independent samples of the form [symbol] aᵢ, bᵢ=aᵢ·s+eᵢ [symbol] ϵR_{q}×R_{q} where each aᵢ ϵR_{q} is a uniformly random polynomial and each

$${e}_{i} {←}^{uniformly} χ .$$

The main attraction of R-LWE is their worst-case hardness theorem which essentially says that solving certain instantiations is at least as hard as quantumly solving an approximate shortest vector problem (approx-SVP) on any ideal lattice, ie a lattice corresponding to an ideal of a ring.

The proposed method also relies on the ring-LWE hardness based on lattice which has been considered as one of the alternative approaches in post-quantum cryptography.

Further the method uses a fully homomorphic public key encryption (FHE) system where the addition of ciphertexts hold true, ie Enc(m₁, sk₁)+Enc(m₂, sk₂)=Enc(m₁+m₂, sk₁+sk₂). In single-key FHE, the ciphertext is decrypted by each user using a joint secret key which is problematic in a multi-user scenario. The notion of multi-key homomorphic encryption (MKHE) allows each user to partially decrypt the new ciphertext with his own secret key to retrieve the actual message. This is used to define a key-exchange protocol between two registered users under the Pi-Control™ platform.

The proposed method also has a signer-verifier setup which works using the shared secret key. In accordance with the system and method as disclosed there may be at least two participating users-one who signs a document and the other verifies the signature. Further the at least two users interact between each other through the Pi-Control™ platform through a secured channel of communication. The verifier uses a zero-knowledge-proof which means that, during the process, the user can verify the signer's ownership without using any of the signer's private information, hence ensuring a cryptographically secure process.

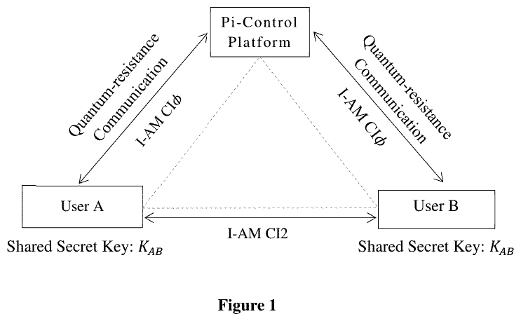

Referring to FIG. 1, illustrates a system in accordance with an exemplary embodiment of the present disclosure. The system 100 may comprise a server 102. The server 102, may be configured to host Pi-Control™ Platform or the platform. Further the server 102 hosting the platform may be communicably connected via network to at least one first user A 104, and to at least one second user B 106.

Further in accordance with the exemplary embodiment, the communication between the at least one first user A 104, and the at least one user B 106 may be possible via the platform server 102. For ease of disclosure the at least one first user A 104 may be represented as User A. Further for ease of disclosure the at least one second user B 106 may be represented as User B. The communication between the server 102, and the User A 104, and/or User B 106, may be via the secured and encrypted network.

The network may be configured to use a CTR-based AES256 encryption. Further the AES256 encryption is provided with a salted hash to the shared key with HMAC-SHA256, thereby adding a cryptographically secure random number (nonce) to the key each time preventing the possibility of key re-use.

Further in an aspect of the present disclosure a key encapsulation mechanism to build a secure communication channel between two registered users is disclosed. Further the public key encryption scheme of ring learning with errors (ring-LWE) prevents any information being shared with the Pi-control server during the key exchange process.

In accordance with the system the Verifier and Signer are configured to run a handshake or connect with the platform 102 and generate the secret keys K_{A} and K_{B} respectively, i.e., User A 104 may be verifier, and User B 106 may be signer. Further User A 104 and the User B 106 may be configured to run the Identity Based Authenticated Key Agreement Protocol in order to generate the symmetric key K_{AB}. This shared secret key is called as the collective identity.

Further in accordance with the exemplary implementation of the present disclosure the system 100 may initiate by creating the individual id for the two users, User A 104 and User B 106 through the handshake. After the handshaking, the platform 102 acquires the information which can be used to generate the individual id for the signer 104 and the verifier 106.

The system 100, in accordance with the present disclosure each of the users 104, and 106 and the platform 102 generates a cryptographically secure pseudo random number. This number may be split into a plurality of shares using the Shamir's secret sharing protocol with a certain number of user and threshold values.

The server 102, hosting the platform 102, may comprise at least one processor, at least one memory, and at least one module, configured to process, store, execute the instructions, the encryption-decryption algorithm, and other instructions and algorithm as disclosed in the exemplary embodiments.

Further User A, and the User B may be configured to access the platform/server 102, using a device or devices having at least one processor, at least one memory, and at least one module, configured to process, store, execute the instructions, the encryption-decryption algorithm, and other instructions and algorithm as disclosed in the exemplary embodiments.

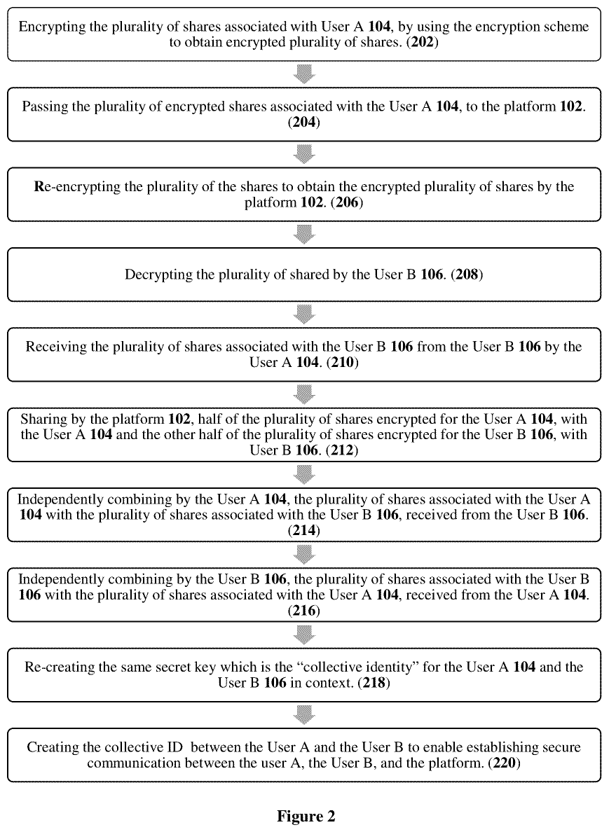

The User A 104, the User B 106, and the platform 102 may undergo a key distribution mechanism. User A 104 may take half of his shares and sends it to the verifier, i.e., User B 106 through the secured channel created by the platform 102 in the way as illustrated in FIG. 2. The FIG. 2, illustrates an exemplary method for exchanging keys, and distribution of keys in accordance with the present disclosure. The method as disclosed at step 202, encrypting the plurality of shares associated with User A 104, by using the encryption scheme to obtain encrypted plurality of shares.

Further the at step 204, passing the plurality of encrypted shares associated with the User A 104, to the platform 102. Further the platform 102, may be configured to decrypt the plurality of encrypted shares, using the same key to decrypt and encrypt.

The platform 102 may be configured to have the required information to generate the unique identity for the registered user A from the handshake. Further at step 206 re-encrypting the plurality of the shares to obtain the encrypted plurality of shares by the platform 102. The re-encryption of the plurality of shares may be performed by the platform 102 to be passed to the User B 106.

Further in accordance with the system 100, at step 208, decrypting the plurality of shared by the User B 106. Further the platform 102, at step 210, receiving the plurality of shares associated with the User B 106 from the User B 106 by the User A 104. Further the sharing of the plurality of shares between User B 106 and the User A 104 using the secured channel created by the platform 102.

In step 212, sharing by the platform 102, half of the plurality of shares encrypted for the User A 104, with the User A 104 and the other half of the plurality of shares encrypted for the User B 106, with User B 106. At step 214, independently combining by the User A 104, the plurality of shares associated with the User A 104 with the plurality of shares associated with the User B 106, received from the User B 106. Further at step 216, independently combining by the User B 106, the plurality of shares associated with the User B 106 with the plurality of shares associated with the User A 104, received from the User A 104. In accordance with the aspect of the embodiment for the actual key exchange, the User A, and the User B again exchange one share with each other through the secured channel of the platform 102.

Further in accordance with the embodiment, at step 218, re-creating the same secret key which is the “collective identity” for the User A 104 and the User B 106 in context. The re-creating of the key is enabled using the shared information and the previously combined information, by the concept of Shamir secret sharing.

At step 220, creating the collective ID between the User A and the User B to enable establishing secure communication between the user A, the User B, and the platform 102.

a. QUANTUM SAFE I-AM® CI2-MKHE Based

TABLE 1

| A | Pi-Control ™ Platform | B |
|---|---|---|
| I-AM ® Crypto-ID: K_{A} using | | I-AM ® Crypto-ID: K_{B} using key |
| key exchange from I-AM ® | | exchange from I-AM ® Clϕ |
| Clϕ | | |
| Communication between A & Pi-Control ™ Platform is | | |
| Encrypted with KA | | |

Communication between B & Pi-Control ™ Platform is
Encrypted with K_{B}

Key and Shares Generation
Set public parameters (N, χ, n, p, q, α, a)

| | | |
|---|---|---|
| Generate : | | Generate : |
| sk_{A} := (1, s_{A}), | | sk_{B} := (1, s_{B}), |
| ${s}_{A} = {\sum }_{i = 0}^{n} {s}_{i} {x}^{i} ∈ {R}_{q} ,$ | | ${s}_{B} = {\sum }_{i = 0}^{n} {s}_{i} {x}^{i} ∈ {R}_{q} ,$ |
| ${s}_{i} {\to }^{uniform} χ$ | | ${s}_{i} {\to }^{uniform} χ$ |
| pk_{A} = (b_{A}, a) | | pk_{B} = (b_{B}, a) |
| Secret Random Number: S_{A} | Split (S_{G}, 3, 4) | Secret Random Number: S_{B} |
| Split (S_{A}, 3, 4) → [a₁, ... , a₄] | → [g₁, ... , g₄] | Split (S_{B}, 3, 4) → [b₁, ... , b₄] |
| Encryption: | | Encryption: |
| A₁ = HEnc ([a₁, a₂], pk_{A}) → | | ← B₁ = HEnc([b₁, b₂], pk_{B}) |
| A₂ = HEnc([a₃, a₄], pk_{A}) → | | ← B₂ = HEnc([b₃, b₄], pk_{B}) |
| | Addition: | |
| | S₁ = A₁ + B₁ + [g₁, g₂] → | |
| | ← S₂ = A₂ + B₂ + [g₃, g₄] | |
| Partial decryption: | | Partial decryption: |
| pd_{A} = ParDec(S₂, sk_{A}, B₂) | | pd_{B} = ParDec(S₁, sk_{B}, A₁) |
| Re-encrypt: | | Re-encrypt: |
| PD_{A} = HEnc(pd_{A}, pk_{B}) → | | ← PD_{B} = HEnc (pd_{B}, pk_{A}) |
| Final decryption: | | Final decryption: |
| $[ {z}_{1} , {z}_{2} ] = HDec ( {PD}_{B} , {sk}_{A} ) = [ \begin{matrix}{a}_{1} + {b}_{1} + {g}_{1} , \\ {a}_{2} + {b}_{2} + {g}_{2}\end{matrix} ]$ | | $[ {z}_{3} , {z}_{4} ] = HDec ( {PD}_{A} , {sk}_{B} ) = [ \begin{matrix}{a}_{3} + {b}_{3} + {g}_{3} , \\ {a}_{4} + {b}_{4} + {g}_{4}\end{matrix} ]$ |

Key Exchange

| | | |
|---|---|---|
| [z₁, z₂] | | [z₃, z₄] |
| z₂′ = Enc(z₂, K_{A}) → | z₂″ = Enc(Dec(z₂′, K_{A}), K_{B}) → | ← z₃′ = Enc (z₃, K_{B}) |
| | z₃″ = Enc(Dec(z₃′, K_{B}), K_{A}) ← | |
| z₃ = Dec(z₃″, K_{A}) | | z₂ = Dec(z₂″, K_{B}) |
| Reconstruct (z₁, z₂, z₃) = K_{AB} = S_{A} + S_{B} + S_{G} | | Reconstruct (z₄, z₅, z₆) = K_{AB} = S_{A} + S_{B} + S_{G} |
| K_{AB} = Shared Secret Key | | K_{AB} = Shared Secret Key |
| (aka Collective Identity) | | (aka Collective Identity) |

In another exemplary implementation of the present embodiments a concept of Learning with errors on a ring structure (ring-LWE) is disclosed. In the present invention, a key encapsulation is done using ring-LWE to securely exchange information between two users, A and B, who have been registered under I-AM® and obtained valid crypto ids a priori.

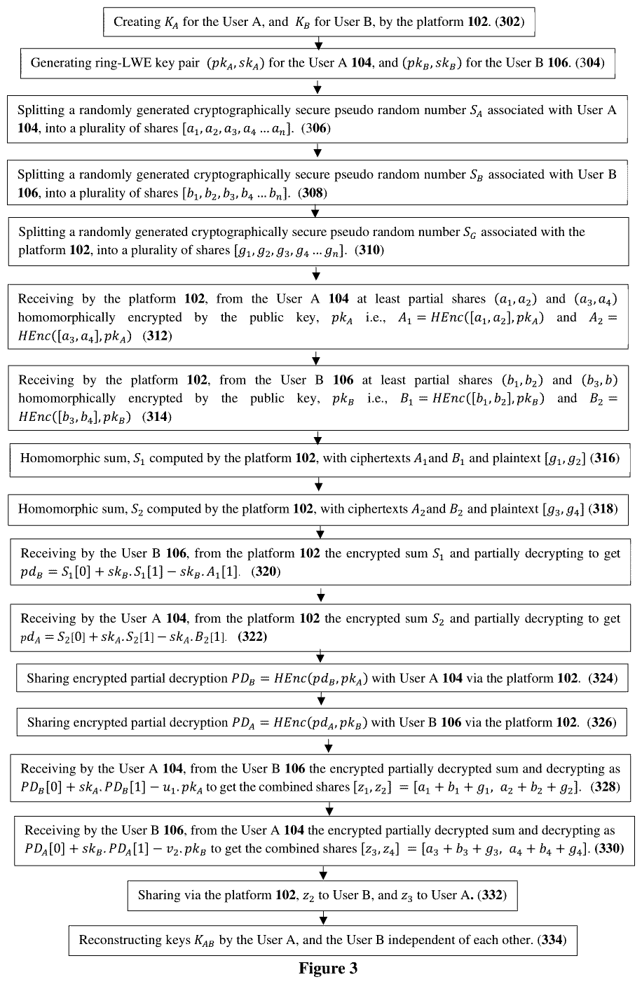

Referring to Table 1 illustrates a technical flow of key exchange between two registered users using MKHE, in accordance with an exemplary embodiment of the present disclosure. Further FIG. 3 with the table 1, enable the key exchange between the User A, and the User B.

The method as disclosed in accordance with the exemplary embodiment, at step 302, creating or generating by the platform 102, a unique key K_{A} for the User A 104, and another unique key K_{B} for the User B 106. The unique key K_{A} for the User A 104 may be an encrypted key, and another unique key K_{B} for the User B 106 may be an encrypted key.

Further at step 304, an implementation may be initiated by each user i.e., User A and User B generating a public key pair (pk_{A}, sk_{A}) and (pk_{B}, sk_{B}) based on ring-LWE parameters.

Further at step 306, splitting a randomly generated cryptographically secure pseudo random number S_{A} associated with User A 104, into a plurality of shares [a₁, a₂, a₃, a₄ . . . aₙ]. Further the splitting of the randomly generated cryptographically secure pseudo random number S_{A} into the plurality of shares [a₁, a₂, a₃, a₄ . . . aₙ] may be based on a threshold value. For e.g., S_{A} is split using a (3,4) threshold (n=2*(3−1), k=3) and the shares are taken as [a₁, a₂, a₃, a₄]. Further for the ease of explanation [a₁, a₂, a₃, a₄ . . . aₙ] may be interchangeably be represented as [a₁, a₂, a₃, a₄].

Further at 308, splitting a randomly generated cryptographically secure pseudo random number Sp associated with User B 106, into a plurality of shares [b₁, b₂, b₃, b₄ . . . bₙ]. Further the splitting of the randomly generated cryptographically secure pseudo random number S_{B} into the plurality of shares [b₁, b₂, b₃, b₄ . . . bₙ] may be based on a threshold value. For e.g., S_{B} is split using a (3, 4) threshold (n=2*(3−1), k=3) and the shares are taken as [b₁, b₂, b₃, b₄]. Further for the ease of explanation [b₁, b₂, b₃, b₄ . . . bₙ] may be interchangeably be represented as [b₁, b₂, b₃, b₄].

At step 310, splitting a randomly generated cryptographically secure pseudo random number S_{G} associated with the platform 102, into a plurality of shares [g₁, g₂, g₃, g₄ . . . gₙ]. Further the splitting of the randomly generated cryptographically secure pseudo random number S_{G} into the plurality of shares [g₁, g₂, g₃, g₄ . . . gₙ] may be based on a threshold value. For e.g., S_{G} is split using a (3,4) threshold (n=2*(3−1), k=3) and the shares are taken as [g₁, g₂, g₃, g₄]. Further for the ease of explanation [g₁, g₂, g₃, g₄ . . . gₙ] may be interchangeably be represented as [g₁, g₂, g₃, g₄].

In an aspect of the exemplary embodiment, the step 306, 308, 310 may be performed at least partially simultaneously at the respective server/devices. In another aspect the step 306, 308, 310 may be performed consecutively at the respective server/devices. In yet another aspect the step 306, 308, 310 may be performed consecutively with at least partial overlap between the steps 306, 308, 310 at the respective server/device. Further sequence of the steps 306, 308, 310 being performed may be changed.

Further in accordance with the exemplary embodiment at step 312, sharing by the User A 104 to the platform 102, at least partial shares [a₁, a₂] and [a₃, a₄] from the plurality of shares [a₁, a₂, a₃, a₄ . . . aₙ] after homomorphically encrypting using the public key, pk_{A} of User A 104. Further at step 314, simultaneously sharing by the User B 106 to the platform 102, at least partial shares [b₁, b₂] and [b₃, b₄] from the plurality of shares [b₁, b₂, b₃, b₄ . . . bₙ] after homomorphically encrypting using the public key, pk_{B} of User B 106. The users are configured to share the shares by encrypting with their own public keys, ie A₁=HEnc([a₁, a₂], pk_{A}), A₂=HEnc([a₃, a₄], pk_{A}), B₁=HEnc([b₁, b₂], pk_{B}), B₂=HEnc([b₃, b₄], pk_{B}) hence keeping them oblivious to the platform 102.

In accordance with the exemplary embodiment to establish a secured connection between the user A, and the user B, at step 316, receiving by the platform 102, from the User A at least encrypted partial shares A₁ and from the User B at least encrypted partial shares B₁, the platform 102 performs a homomorphic addition of ciphertexts. Then the platform 102 performs a plaintext and ciphertext addition with its partial shares [g₁, g₂] to obtain S₁=A₁+B₁+[g₁, g₂].

At step 318, receiving by the platform 102, from the User A at least encrypted partial shares A₂ and from the User B at least encrypted partial shares B₂, the platform 102 performs a homomorphic addition of ciphertexts. Then the platform 102 performs a plaintext and ciphertext addition with its partial shares [g₃, g₄] to obtain S₂=A₂+B₂+[g₃, g₄].

At step 320, receiving from the platform 102, the User B 106 partially decrypts the encrypted sum S₁ with his secret key sk_{B} and the ciphertext A₁, where partial decryption pd_{B}=S₁[0]+sk_{B}. S₁[1]−sk_{B}. A₁[1]. Further in step 324, shares PD_{B}=HEnc(pd_{B}, pk_{A}) with the User A 104 via the platform 102 after re-encrypting it with the public key pk_{A} of User A 104.

Further in step 328, the User A 104 will decrypt the partially decrypted information by PD_{B}[0]+sk_{A}. PD_{B}[1]−u₁·pk_{A} to obtain the sum of shares as [z₁, z₂]=[a₁+b₁+g₁, a₂+b₂+g₂].

In a simultaneous instance, At step 322, receiving from the platform 102, the User A 104 partially decrypts the encrypted sum S₂ with his secret key sky and the ciphertext B₂, where partial decryption pd_{A}=S₂[0]+sk_{A}. S₂[1]−sk_{A}. B₂[1]. Further in step 326, shares PD_{A}=HEnc(pd_{A}, pk_{B}) with the User B 106 via the platform 102 after re-encrypting it with the public key pk_{A} of User B 106.

Further in step 330, the User B 106 will decrypt the partially decrypted information by PD_{A}[0]+sk_{B}. PD_{A}[1]−v₂·pk_{B} to obtain the sum of shares as [z₃, z₄]=[a₃+b₃+g₃, a₄+b₄+g₄].

The exemplary embodiment may be further configured at step 332, for sharing via the platform 102, z₂ to User B 106, and z₃ to User A 104. Further at step 334, reconstructing keys K_{AB} by the User A, and the User B independent of each other. The keys K_{AB} can be re-constructed by using z₁, z₂, z₃, User A 104 can reconstruct to get the secret K_{AB}=S_{A}+S_{B}+S_{G} and using z₂, z₃, z₄, User B 106 can reconstruct to get the same secret K_{AB}=S_{A}+S_{B}+S_{G}.

b. Encryption Scheme

In accordance with the exemplary embodiment, an encryption scheme deployed by the platform 102, may be symmetric encryption, i.e., the same key may be used for encryption and decryption. For ease of the disclosure User A may be interchangeably be referred as encryptor. Further for ease of the disclosure User B may be interchangeably be referred as decryptor.

The encryptor takes the id and produces an HMAC-SHA256 hash using a salt S. This is used to generate an AES256 key for encrypting the message. This message along with the salt S is sent as a cipher to the decryptor.

The decryptor takes the same id and produces an HMAC-SHA256 hash using the same salt S. He can generate the same AES256 key and decrypt successfully.

The encryptor and decryptor should have the same id available through handshaking. The encryption scheme is based on CTR based AES-256. In the process of key distribution and key exchange, all communications between the user and the Pi-platform happens through the secured channel established using the I-AM crypto ID. To generate the AES key, the crypto-ID can be used as a seed as both the user and the platform will have the I-AM Crypto ID. This means that, for every encryption between the user and the platform, the same AES key gets generated. This will create a security problem due to key re-use. To avoid this:

A random salt, T is added to the I-AM Crypto-ID, say K_{A}

$$Consider seed = Hash ( {K}_{A} + T )$$

where HMAC-SHA512 is used for hash

This seed can be used to generate the AES-256 key for a single instance of encryption.

The salt, T is shared along with the encrypted information. This solves the key re-use issue as each time the seed gets randomized using a new salt.

c. QUANTUM SAFE I-AM® CI2—Digital Signature

TABLE 2

| | Pi-Control ™ | |
|---|---|---|
| A (Signer) | Platform | B (Verifier) |
| I-AM ® Crypto-ID: K_{A} | | I-AM ® Crypto-ID: K_{B} |
| K_{AB} = Shared Secret Key | | K_{AB} = Shared Secret Key |
| | Doc_{A} = Doc_{B} | T_{B} = True Random |
| | | Number( ) |
| | | Q = [Hash(K_{B} + T_{B})] |
| | | Enc (Q, K_{AB}) |
| | ← Enc(Q, K_{AB}) | |
| Q ← Dec(Enc(Q, K_{AB}), | | |
| K_{AB}) | | |
| S = Hash(K_{A} + Q) | S → | |
| Doc_{A} | | Doc_{B} |
| D_{A} = Hash (Doc_{A}) + S | | D_{B} = Hash(Doc_{B}) + S |
| Sign: | T_{ID} → | |
| T_{ID} = Enc (D_{A}, K_{AB}) | | |
| | | D' = Dec (T_{ID}, K_{AB}) |
| | | Verify: |
| | | IF (D′ == D_{B}) |
| | | Verification Successful |
| | | ELSE |
| | | Verification Failed |

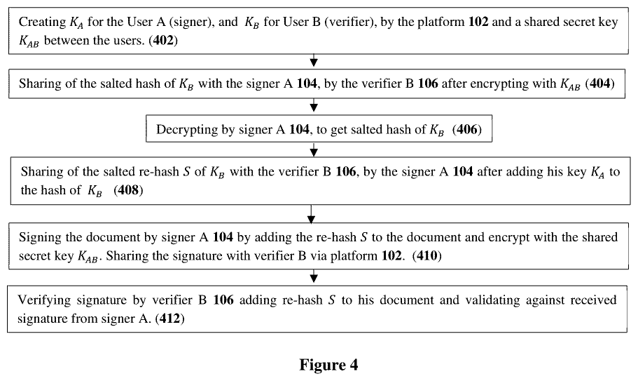

The Table 2, illustrates a technical flow to represent the signer/verifier protocol deployed by the platform 102. In accordance with the exemplary embodiment, the User A may be referred as ‘signer’, the User B may be referred as ‘verifier’, and K_{AB} is the “collective id” generated during key exchange. Further FIG. 4 with the table 2 defines a digital signature protocol between User A 104 (signer) and User B 106 (verifier), both registered under the platform 102 and sharing a common secret key.

The method as disclosed in accordance with the exemplary embodiment, at step 402, creating or generating by the platform 102, a unique key K_{A} for the User A 104, and another unique key K_{B} for the User B 106 and a shared secret key K_{AB} between the users.

At step 404, the verifier B shares the HMAC-SHA512 hash of his I-AM®-Crypto id, K_{B} encrypted with the shared secret K_{AB}, via the platform 102. Further in step 506 the signer A decrypts with the shared secret K_{AB} to get the hash of the verifier's id.

Further at step 408, signer A adds his own I-AM®-Crypto id K_{A} to it and creates a re-hash S with HMAC-SHA512 which he shares with the verifier B via the platform 102.

Further in step 410, the re-hash S is added to the document/message to be signed and a new HMAC-SHA512 hash T is created. This hash is encrypted with collective id K_{AB} of the signer-verifier and shared with the verifier via the platform 102.

In accordance with the exemplary embodiment to verify the signature, in step 412, the verifier B adds the shared re-hash S to his version of the document/message and validate against the decrypted hash T as receiving from the signer A.

The exemplary embodiment may be configured so that, during the entire process of signing and verification, the information that is shared between A and B is masked efficiently by using randomized salt elements which reduces collision as well as dictionary type attacks.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the scope of the present disclosure.

We claim:

1. A quantum safe method for creation and verification of digital signature, comprising:
encrypting, a plurality of shares associated with a User A, by using an encryption scheme to obtain encrypted plurality of shares;
passing, the plurality of encrypted shares associated with the User A, to the platform;
re-encrypting, the plurality of the shares to obtain the encrypted plurality of shares by the platform;
decrypting, the plurality of shares shared by the User B;
receiving, the plurality of shares associated with the User B from the User B by the User A;
sharing, by the platform, half of the plurality of shares encrypted for the User A, with the User A and the other half of the plurality of shares encrypted for the User B, with User B;
independently combining, by the User A, the plurality of shares associated with the User A with the plurality of shares associated with the User B, received from the User B;
independently combining, by the User B, the plurality of shares associated with the User B with the plurality of shares associated with the User A, received from the User A;
re-creating, the same secret key which is the “collective identity” for the User A and the User Bin context; and
creating, the collective ID between the User A and the User B to enable establishing secure communication between the user A, the User B, and the platform.

2. The quantum safe method for creation and verification of digital signature as claimed in claim 1, comprises creating or generating, by the platform, a unique key K_{A} for the User A, and another unique key K_{B} for the User B.

3. The quantum safe method for creation and verification of digital signature as claimed in claim 1, comprises generating, public-private key pair (pk_{A}, sk_{A}) for the user A and a public-private key pair (pk_{B}, sk_{B}) for the user B based on the parameters of RLWE.

4. The quantum safe method for creation and verification of digital signature as claimed in claim 1, comprises splitting, a randomly generated cryptographically secure pseudo random number S_{A} associated with User A, into a plurality of shares [a₁, a₂, a₃, a₄ . . . aₙ].

5. The quantum safe method for creation and verification of digital signature as claimed in claim 1, comprises splitting, a randomly generated cryptographically secure pseudo random number Sp associated with User B, into a plurality of shares [b₁, b₂, b₃, b₄ . . . bₙ].

6. The quantum safe method for creation and verification of digital signature as claimed in claim 1, comprises splitting, a randomly generated cryptographically secure pseudo random number S_{G} associated with the platform, into a plurality of shares [g₁, g₂, g₃, g₄ . . . gₙ].

7. The quantum safe method for creation and verification of digital signature as claimed in claim 1, comprises receiving, by the platform, at least partial shares [a₁, a₂] and [a₃, a₄] from the plurality of shares [a₁, a₂, a₃, a₄ . . . aₙ] from the User Aby homomorphically encrypting using the key pk_{A}.

8. The quantum safe method for creation and verification of digital signature as claimed in claim 1, comprises receiving, by the platform, at least partial shares [b₁, b₂] and [b₃, b₄] from the plurality of shares [b₁, b₂, b₃, b₄ . . . bₙ] from the User B by homomorphically encrypting using the key pk_{B}.

9. The quantum safe method for creation and verification of digital signature as claimed in claim 1, comprises homomorphic addition, by the platform, of the at least encrypted partial shares A₁=HEnc(a₁, a₂, pk_{A}) and A₂=HEnc(b₁, b₂, pk_{A}) and [g₁, g₂].

10. The quantum safe method for creation and verification of digital signature as claimed in claim 1, comprises homomorphic addition, by the platform, of the at least encrypted partial shares A₂=HEnc(a₃, a₄, pk_{A}) and B₂=HEnc(b₃, b₄, pk_{A}) and [g₃, g₄].

11. The quantum safe method for creation and verification of digital signature as claimed in claim 1, comprises receiving, by the User B encrypted sum and partially decrypting it to get pd_{B}=S₁[0]+sk_{B}·S₁[1]−sk_{B}·A₁[1].

12. The quantum safe method for creation and verification of digital signature as claimed in claim 1, comprises sharing, with the User A the partially decrypted sum after encrypting it as PD_{B}=HEnc(pd_{B}, pk_{A}).

13. The quantum safe method for creation and verification of digital signature as claimed in claim 1, comprises receiving, by the User A encrypted sum and partially decrypting it decrypting to get pd_{A}=S₂[0]+sk_{A}·S₂[1]−sk_{A}·B₂[1].

14. The quantum safe method for creation and verification of digital signature as claimed in claim 1, comprises sharing, with the User B the partially decrypted sum after encrypting it as PD_{A}=HEnc(pd_{A}, pk_{B}).

15. The quantum safe method for creation and verification of digital signature as claimed in claim 1, comprises receiving, by the User A from the User B, the encrypted partially decrypted sum and decrypt it as PD_{B}[0]+sk_{A}·PD_{B}[1]−u₁·pk_{A} to get the combined shares [z₁, z₂]=[a₁+b₁+g₁, a₂+b₂+g₂].

16. The quantum safe method for creation and verification of digital signature as claimed in claim 1, comprises receiving, by the User B from the User A, the encrypted partially decrypted sum and decrypt it as PD_{A}[0]+sk_{B}·PD_{A}[1]−v₂·pk_{B} to get the combined shares [z₃, z₄]=[a₃+b₃+g₃, a₄+b₄+g₄].

17. The quantum safe method for creation and verification of digital signature as claimed in claim 1, comprises sharing, via the platform 102, z₂ to User B, and z₃ to User A.

18. The quantum safe method for creation and verification of digital signature as claimed in claim 1, comprises reconstructing, shared key K_{AB}=S_{A}+S_{B}+S_{G} by the User A, and the User B independent of each other and oblivious to the platform.

19. The quantum safe method for creation and verification of digital signature as claimed in claim 1, comprises creating or generating, by the platform, a unique key K_{A} for the User A (signer), and another unique key K_{B} for the User B (verifier), and a shared secret key the “collective identity” between the signer and the verifier.

20. The quantum safe method for creation and verification of digital signature as claimed in claim 1, comprises sharing with the signer, a salted hash of the verifier id K_{B} by the verifier after encrypting it with K_{AB}.

21. The quantum safe method for creation and verification of digital signature as claimed in claim 1, comprises decryption by the signer, the received hash from the verifier.

22. The quantum safe method for creation and verification of digital signature as claimed in claim 1, comprises signer sharing a re-hash with the verifier, by adding the id K_{A} by the signer to the received hash from the verifier.

23. The quantum safe method for creation and verification of digital signature as claimed in claim 1, comprises signer signing and sharing signature with verifier, by adding the re-hash to the document/message and encrypt with K_{AB}.

24. The quantum safe method for creation and verification of digital signature as claimed in claim 1, comprises verifier validating, received signature against his document/message added to the received re-hash from the signer.
